(19) United States
(12) Patent Application Publication
(10) Pub. No.: US 2025/0150388 A1
(43) Pub. Date: May 8, 2025

(54) ROUTING INFORMATION GENERATION DEVICE, PROGRAM AND ROUTING INFORMATION GENERATION METHOD

(71) Applicant: Nippon Telegraph and Telephone Corporation, Tokyo (JP)

(72) Inventors: Tomohiro KORIKAWA, Musashino-shi, Tokyo (JP); Chikako TAKASAKI, Musashino-shi, Tokyo (JP); Masafumi SHIMIZU, Musashino-shi, Tokyo (JP); Naoki TAKAYA, Musashino-shi, Tokyo (JP)

(21) Appl. No.: 18/835,055

(22) PCT Filed: Feb. 15, 2022
(86) PCT No.: PCT/JP2022/005842

§ 371 Date: Aug. 1, 2024

(51) Int. Cl. H04L 45/42; H04W 72/0446

(52) U.S. Cl. CPC H04L 45/42; H04W 72/0446

(57) ABSTRACT

A routing information generation device: generates divisional generation periods for a generation period for which routing information for a network including nodes is to be generated, the divisional generation periods each generated by dividing the generation period into time slots; for each time slot in each divisional generation period, determines, for each two of the nodes, whether communication is possible based on at least one of location information, specifications, and communication environment information of the two and generates a network model including links among communicable nodes and the communicable nodes; generates routing information for each network model; calculates an evaluation value of each network model based on its communication quality; and for each divisional generation period, calculates an evaluation value based on the evaluation values of the network models of the time slots included in the divisional generation period and selects a divisional generation period with a best evaluation value.

### TECHNICAL FIELD

The present invention relates to a routing information generation device, a program, and a routing information generation method that generate routing information for a network including mobile objects.

### BACKGROUND ART

By enabling communications between portable terminals and low-orbit communication satellites and/or base stations flying in the stratosphere (flight base stations), mobile communication services will become possible even in areas where it is difficult to install terrestrial base stations. Communication satellites and flight base stations are constantly moving and thus dynamic routing based on the positional relationships between communication satellites and flight base stations is required. According to the techniques described in Non-Patent Literatures 1 and 2, routing information is updated at regular intervals/periods based on the trajectory of a mobile node.

### CITATION LIST

### Non Patent Literature

[Non Patent Literature 1] Werner, M., “A Dynamic Routing Concept for ATM-Based Satellite Personal Communication Networks,” IEEE Journal on Selected Areas in Communications Vol. 15 No. 8, pp. 1636-48, 1997.
[Non Patent Literature 2] Li, Yuanjie, et al., “'Internet in Space' for Terrestrial Users via Cyber-Physical Convergence,” In Proceedings of the 20th ACM Workshop on Hot Topics in Networks (HotNets' 21), pp. 163-70, 2021.

### SUMMARY OF THE INVENTION

### Technical Problem

Communication within a network including mobile nodes requires dynamic routing based on, in addition to the positional relationships between nodes, the changes in the communication environment, such as the weather and electromagnetic interference with other communications. When mobile nodes move at high speed, as routing based on existing protocols between nodes is difficult, a method of providing pre-calculated routing to the nodes may be considered. The techniques described in Non-Patent Literatures 1 and 2 are limited to application to a group of mobile nodes having a specific configuration or trajectory and do not take into account the changes in the communication environment in pre-calculation of routing.

The present invention has been made in view of such a background, and an object of the present invention is to enable pre-calculation of routing in a network including mobile nodes with taking into account the communication environment.

### Solution to Problem

In order to solve the above-mentioned problems, according to the present invention, there is provided a routing information generation device including: a period division part configured to divide a generation period, which is a period for generating routing information for a network including a node that is a mobile node or a fixed node, into one or more time slots to generate divided generation periods: a model generation part configured to determine, for each time slot included in the one or more divided generation periods, whether communication is possible between two of the nodes based on at least one of location information of the nodes in a period indicated by the time slot, specifications of the nodes, and communication environment information at the locations of the nodes and to generate a network model including a link between two of the nodes between which communication is possible and the nodes: a routing part configured to generate routing information for the network model: a model evaluation part configured to calculate an evaluation value based on a communication quality of the network model: a selection part configured to calculate an evaluation value of the divided generation period based on the evaluation values of the network models corresponding to the time slots included in the divided generation period and to select the divided generation period whose evaluation value is the best: and a node management part configured to transmit, to the nodes, the time slots of the selected divided generation period and the routing information associated with the time slots.

### Advantageous Effects of Invention

According to the present invention, it is possible to perform pre-calculation of routing in a network including mobile nodes with taking into account the communication environment.

### BRIEF DESCRIPTION OF THE DRAWINGS

FIG. 1 is a diagram illustrating the overall configuration of a network according to the present embodiment.

FIG. 2 is a functional block diagram of a routing information generation device according to the present embodiment.

FIG. 3 is a diagram for explaining divisional generation periods according to the present embodiment.

FIG. 4 is a flowchart of routing information generation processing according to the present embodiment.

FIG. 5 is a hardware configuration diagram illustrating an example of a computer that implements functions of the routing information generation device according to the present embodiment.

### DESCRIPTION OF EMBODIMENTS

### Overview of Routing Information Generation Device

A routing information generation device in a mode (embodiment) for carrying out the present invention will be described below. The routing information generation device performs routing (generates routing information) in a network including mobile nodes, such as communication satellites and flying base stations (flight base stations), that move along trajectories and fixed nodes installed on the ground. A flight base station is an unmanned aircraft such as a balloon or a drone that has a base station function.

The routing information generation device generates in advance routing information for a generation period, which is a predetermined period in the future. “In advance” means before performing path control (transfer of communication packets) based on the routing information. The routing information generation device divides the generation period into one or more time slots and generates one or more divided generation periods (divisional generation periods). Next, the routing information generation device calculates, for each time slot, a communication quality (communication performance) between mobile nodes and/or between mobile nodes and fixed nodes based on the locations and communication environment information of the mobile nodes to determine whether communication is possible between the nodes, and generates a network model. Further, the routing information generation device generates routing information for each network model and calculates a communication quality between nodes. Subsequently, the routing information generation device calculates, for each divisional generation period, the communication quality over the entire generation period based on the communication qualities of the network models of the time slots included in the divisional generation period. Lastly, the routing information generation device identifies a divisional generation period with the best communication quality among the one or more divisional generation periods and transmits routing information for each time slot included in the divisional generation period to the nodes.

The routing information generation device calculates the communication quality taking into account also the communication environment information in addition to the locations of the mobile nodes and performs routing in advance (before the generation period). Therefore, it is possible to communicate through a communication path with better communication quality than when routing is performed without taking into account the communication environment information. Note that the communication quality includes not only bandwidth (communication speed), also called communication performance, but also delay, (packet) loss rate, jitter, etc.

### Overall Configuration of Network

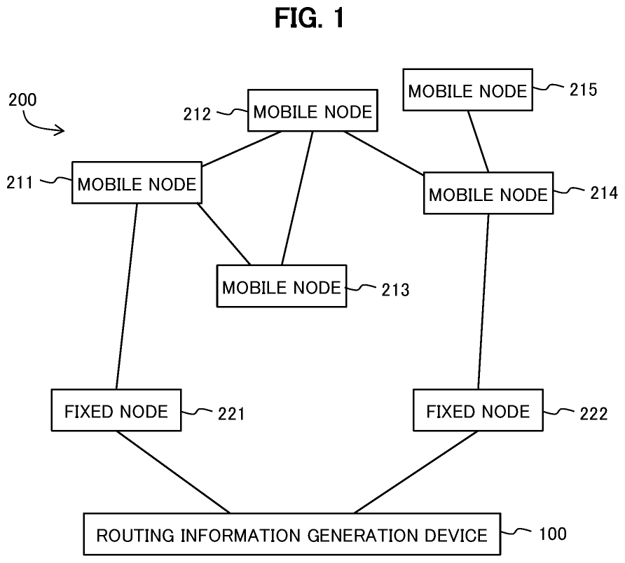

FIG. 1 is a diagram illustrating the overall configuration of a network 200 according to the present embodiment. The network 200 includes mobile nodes 211 to 215 and fixed nodes 221 and 222. A routing information generation device 100 is connected to network 200 and is capable of communicating with the mobile nodes 211 to 215 via the fixed nodes 221 and 222. The mobile nodes 211 to 215 are collectively referred to as a mobile node(s) 210, the fixed nodes 221 and 222 are collectively referred to as a fixed node(s) 220, and the mobile nodes 211 to 215 and the fixed nodes 221 and 222 are collectively referred to as a node(s) 230).

The mobile node 210 is a mobile node with a fixed trajectory, such as a communication satellite or a flight base station utilizing an unmanned aircraft, and its future location can be acquired (calculated). The mobile node 210 is capable of communicating with terrestrial mobile terminals (for example, mobile phones). For example, it is assumed that a mobile terminal can communicate with the mobile node 211 and another mobile terminal can communicate with the mobile node 214. It is also assumed that communication is possible between the mobile nodes 211 and 212 and between the mobile nodes 212 and 214 (see FIG. 1). Then the two mobile terminals can communicate with each other via the mobile nodes 211, 212, and 214.

Between two mobile nodes 210, the availability and quality of communication are determined according to the communication environment such as distance and weather. The same applies to between a mobile node 210 and a fixed node 220.

### Configuration of Routing Information Generation Device

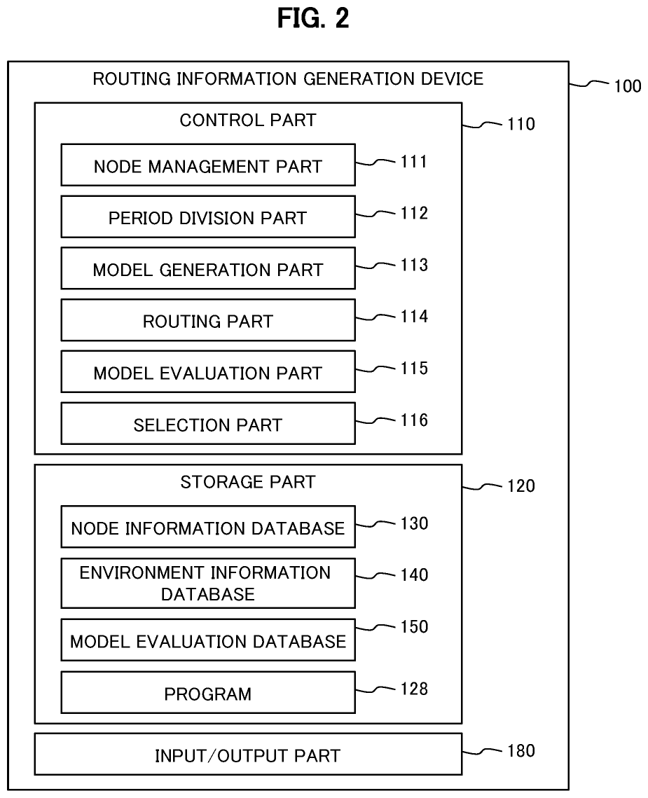

FIG. 2 is a functional block diagram of the routing information generation device 100 according to the present embodiment. The routing information generation device 100 is a computer and includes a control part 110, a storage part 120, and an input/output part 180. User interface devices such as a display, a keyboard, and a mouse are connected to the input/output part 180. The input/output part 180 includes a communication device and is capable of transmitting/receiving data to/from the nodes 230. Further, a media drive may be connected to the input/output part 180, and data can be exchanged using a recording medium.

### Routing Information Generation Device: Storage Part

The storage part 120 includes storage devices such as a read only memory (ROM), a random access memory (RAM), a solid state drive (SSD), and the like. The storage part 120 stores a node information database 130, an environment information database 140, a model evaluation database 150, and a program 128.

The node information database 130 stores specification information, location information, and the like related to the individual mobile nodes 210) and fixed nodes 220. The location information of the mobile node 210 is information related to a trajectory and is referenced when calculating the location of the mobile node 210. The specification information includes a frequency band used for communication in addition to the performance and the number of communication antennas of the node 230).

The environment information database 140 stores weather information that affects the wireless communication between the mobile nodes 210 and between the mobile nodes 210 and the fixed nodes 220. The weather information includes information such as the amount of moisture in the air, the amount of rainfall, and the probability of precipitation. When the mobile node 210) is a communication satellite, weather information on outer space weather that affects wireless communication (propagation loss in wireless communication), such as solar wind and magnetic storms, may be included. The communication environment information stored in the environment information database 140 may include electromagnetic interference with communication other than the communication in the network 200.

The model evaluation database 150 stores information such as time slots, routing information, a communication quality, and the like related to the network model, which will be described later.

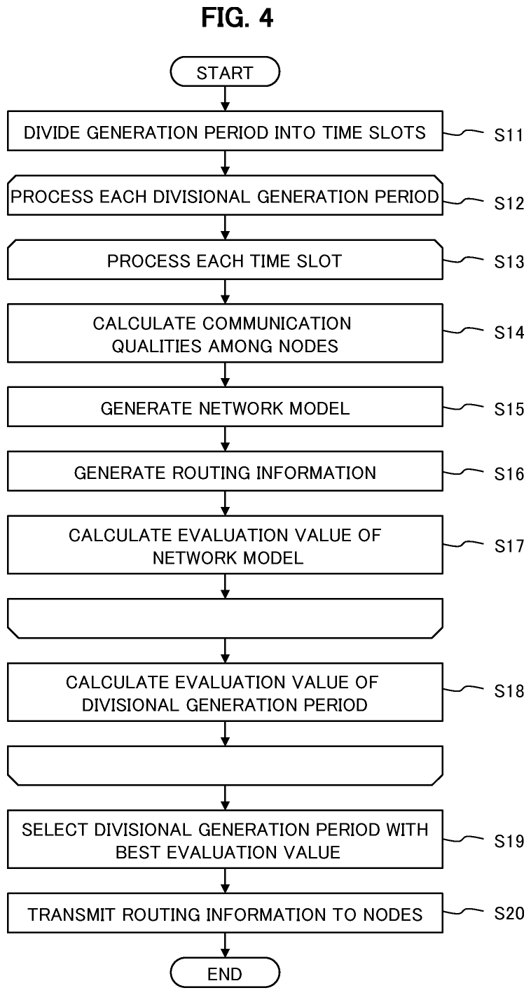

The program 128 includes a description of the procedure in routing information generation processing (see FIG. 4, which will be described later).

### Routing Information Generation Device: Control Part

The control part 110 is configured including a central processing unit (CPU), and includes a node management part 111, a period division part 112, a model generation part 113, a routing part 114, a model evaluation part 115, and a selection part 116.

### Routing Information Generation Device: Control Part: Node Management Part

The node management part 111 acquires information on the mobile nodes 210 and the fixed nodes 220 and stores the information in the node information database 130. For example, the node management part 111 acquires trajectory information of a mobile node 210) from a device that manages the trajectory of the mobile node 210 and stores the trajectory information in the node information database 130. The node management part 111 also acquires weather information and stores the weather information in the environment information database 140). Further, the node management part 111 transmits the later-described generated routing information to the fixed node(s) 220 and to the mobile node(s) 210 via the fixed node(s) 220.

### Routing Information Generation Device: Control Part: Period Division Part

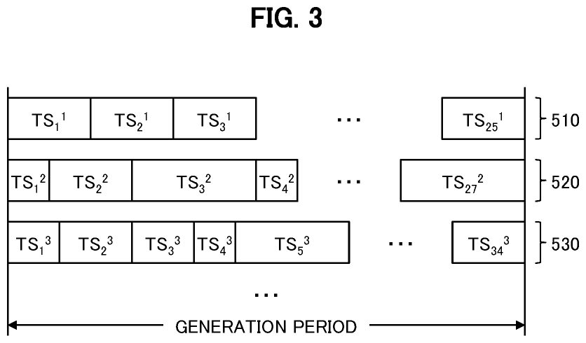

The period division part 112 divides one generation period for which routing is to be performed into time slots and generates one or more divided generation periods (divisional generation periods). FIG. 3 is a diagram for explaining divisional generation periods according to the present embodiment. The divisional generation period 510 is a generation period divided into time slots of a fixed length, and is an example of division into 25 time slots. The divisional generation period 520 is an example of division into time slots repeating a length ratio of 1:2:3. The divisional generation period 530 is an example of division into time slots each having a random length.

### Routing Information Generation Device: Control Part: Model Generation Part

Referring back to FIG. 2, the description of the control part 110 will be continued. The model generation part 113 generates a model (network model) of the network 200 for each time slot based on the locations and the communication environment information of the mobile nodes 210 during the period corresponding to the time slot. The presence or absence of a link between two nodes included in the network model depends on whether communication is possible between the two nodes 230 corresponding to the two nodes. For example, if the distance between two mobile nodes 210 during the period corresponding to a time slot is within the communicable distance, visibility is possible, and the surrounding communication environment satisfies predetermined conditions, a link is present between the nodes of the network model corresponding to the two mobile nodes 210. Visibility being possible means that there are no obstacles, such as buildings, mountains, or the earth, between the two nodes 230, and that the nodes 230 can see each other, which means that wireless communication is possible. The same applies to a link between a mobile node 210) and a fixed node 220. Furthermore, the closer the distance between two nodes 230, the more communication is possible even if the communication environment is poor.

In other words, the model generation part 113 calculates a communication quality between two nodes 230) based on the location information of the nodes 230, the specifications of the nodes 230), and the communication environment at the locations of the nodes 230) and determines that communication is possible if the communication quality satisfies a predetermined condition. Note that when there is no need to distinguish between a node 230 of the network 200 and a node of the network model, they will simply be referred to as a node or node 230).

The model generation part 113 operates as follows. The model generation part 113 calculates the location of a node based on the information in the node information database 130 and acquires communication environment information on the vicinity of the location from the environment information database 140. Next, the model generation part 113 calculates a predicted value of the communication quality (bandwidth, delay, etc.) between nodes, determines that communication is possible when the calculation result satisfies a predetermined condition, and generates a network model assuming that a link is present between the two nodes. The generated network model is stored associated with a divisional generation period and/or a time slot in the model evaluation database 150.

### Routing Information Generation Device: Control Part: Routing Part

The routing part 114 finds the shortest path between two nodes in the network model and generates routing information (routing table for each node). The routing part 114 takes into account the cost of the link when finding the shortest path. The cost of the link is calculated based on the locations of the nodes, distances between the nodes, the specifications of the nodes, and the communication environment information, and is, for example, the reciprocal of the calculated (expected) bandwidth. The generated routing information is stored associated with the network model into the model evaluation database 150.

### Routing Information Generation Device: Control Part: Model Evaluation Part

The model evaluation part 115 evaluates the divisional generation period based on the evaluation of the network model corresponding to a time slot included in the divisional generation period. The model evaluation part 115 calculates an evaluation value of the network model based on the communication qualities. For example, the model evaluation part 115 calculates the evaluation value of the network model based on the bandwidth, delay, loss rate, jitter, etc. between all the nodes. Furthermore, the model evaluation part 115 may calculate the evaluation value of the network model based on the communication qualities between specific nodes or between a mobile node 210 located above a specific area and a specific fixed node 220. The evaluation value is stored associated with the network model into the model evaluation database 150.

### Routing Information Generation Device: Control Part: Selection Part

The selection part 116 calculates an evaluation value of a divisional generation period based on the network models of the time slots included in the divisional generation period. For example, the selection part 116 uses a weighted average of the evaluation values of the network models according to the time slot length as the evaluation value of the divisional generation period. Next, the selection part 116 selects, among the divisional generation periods corresponding to the generation period, a divisional generation period that is evaluated best. Then, the node management part 111 transmits the time slots included in the selected divisional generation period and the routing information (routing tables) for the time slots to the nodes 230 corresponding to the routing information. In the generation period, the nodes 230 transfer communication packets while switching the routing information for each time slot.

### Routing Information Generation Processing

FIG. 4 is a flowchart of the routing information generation processing according to the present embodiment. Assuming that the length of the generation period is one hour, the routing information generation processing is executed every hour, each prior to the generation period.
In step S11, the period division part 112 generates one or more divisional generation periods while dividing one generation period for which routing is to be performed into time slots.
In step S12, the period division part 112 starts repeating steps S13 to S18 for each divisional generation period generated in step S11.
In step S13, the period division part 112 starts repeating steps S14 to S17 for each time slot included in the divisional generation period.
In step S14, the model generation part 113 calculates predicted values of the communication qualities between the nodes 230.
In step S15, the model generation part 113 generates a network model having links between nodes whose predicted values calculated in step S14 satisfy a predetermined condition.
In step S16, the routing part 114 generates routing information of the network model generated in step S15.
In step S17, the model evaluation part 115 calculates the evaluation value of the network model.
In step S18, the selection part 116 calculates the evaluation value of the divisional generation period based on the evaluation values of the network models of the time slots included in the divisional generation period.
In step S19, the selection part 116 selects a divisional generation period with the best evaluation value.
In step S20, the node management part 111 transmits the time slots included in the divisional generation period selected in step S19 and the routing information for the time slots to the nodes 230.

### Features of Routing Information Generation Device

The routing information generation device 100 divides a generation period, which is a period for generating routing information in advance, into time slots and for each time slot, predicts a communication quality based on the locations and communication environment of the nodes and generates a network model. The routing information generation device 100 generates routing information of the network model and calculates an evaluation value of communication quality. The number of the divisional generation periods is one or more. The routing information generation device 100 transmits to the nodes the routing information corresponding to the divisional generation period that is given the best evaluation value.

Existing routing information generation techniques perform routing based on the locations of mobile nodes. The routing information generation device 100 calculates the communication quality taking into account the environment information in addition to the locations of the mobile nodes and performs routing in advance (before the generation period). Therefore, it is possible to communicate through a communication path with better communication quality compared to a case routing is performed without considering environment information.

Further, the routing information generation device 100 calculates routing information in advance and transmits the routing information to the node 230. In comparison to the case where the node 230 calculates routing information using an existing routing protocol, it is possible to reduce the load of the node 230 and to reduce the bandwidth of the link between the nodes 230 used for the routing protocol. Furthermore, it becomes possible to widen the bandwidth of the network 200 used for the original communication (communication as a service to be provided) and extend the usable time.

### Modification Example: Division of Generation Period Into Time Slots

In the above-described embodiment, the period division part 112 divides the period into time slots of a fixed length or time slots of a length having a random change pattern (see FIG. 3). The period division part 112 may divide the period according to the communication quality.

For example, as the first processing, the period division part 112 generates a network model for, of the generation period, a first period (first time slot) of a predetermined period length and generates routing information. Next, as the second processing, the period division part 112 extends the first time slot by a fixed period length as long as the communication quality of the network model satisfies a predetermined condition. When the predetermined condition is not satisfied, the remaining generation period is newly set as the generation period, and the first process and the second process are repeated. In other words, the period division part 112 divides the generation period so that a time slot continues as long as the communication quality of the network model satisfies a predetermined condition in the time slot.

In this way, the routing information generation device 100 can reduce the number of time slots and thus reduce the load for generating the routing information. The routing information generation device 100 may generate the one or more divisional generation periods while changing the first predetermined period length, the fixed period length, the predetermined condition, and the like. For example, when the temporal change in the communication environment is large (when the communication environment is unstable), the routing information generation device 100 may generate divisional generation periods while shortening the predetermined period length and the fixed period length. Conversely, when the communication environment is stable, the routing information generation device 100 may generate divisional generation periods while increasing the predetermined period length and the fixed period length. Alternatively, the routing information generation device 100 may generate divisional generation periods while adjusting the lengths of the predetermined period length and the fixed period length according to the temporal changes in the communication environment. In this way, the routing information generation device 100 can divide the generation period so that the number of time slots is reduced according to the degree of the change in the communication environment.

Note that even when dividing the period into fixed length time slots (see the divisional generation period 510 in FIG. 3), the period division part 112 may determine the time slot length according to the degree of the temporal change in the communication environment. That is, the period division part 112 may divide the generation period so that the larger the temporal change in the communication environment (the more unstable the communication environment), the shorter the time slot length. Also when dividing the period into time slots of a random length (see the divisional generation period 530), the period division part 112 may determine an average time slot length according to the degree of the temporal change in the communication environment.

In this way, the routing information generation device 100 can divide the generation period so that the number of time slots is reduced according to the degree of the change in the communication environment.

### Modification Example: Network for Generating Routing Information

In the embodiment described above, the routing information generation device 100 generates the routing information for the network 200 composed of the nodes 230. In contrast, the routing information generation device 100 may generate the routing information only for the mobile nodes 210. In this case, the fixed nodes 220 may communicate with only the nearest mobile node 210. This simplifies the configuration of the network and reduces the load of generating the routing information.

### Other Modification Examples

Although some embodiments of the present invention have been described above, these embodiments are merely examples and do not limit the technical scope of the present invention. The present invention can take various other embodiments, and various modifications such as omission and substitution can be made without departing from the gist of the present invention. These embodiments and modifications thereof are included in the scope and gist of the invention described in the present specification and the like and are also included in the scope of the invention described in the claims and the equivalent scope thereof.

### Hardware Configuration

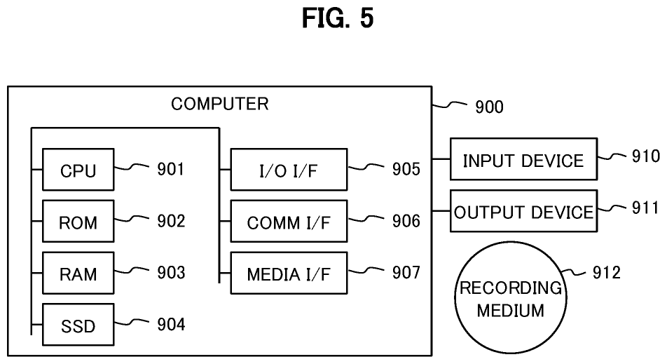

The routing information generation device 100 according to the present embodiment is implemented by, for example, a computer 900 having the configuration illustrated in FIG. 5. FIG. 5 is a hardware configuration diagram illustrating an example of the computer 900 that implements functions of the routing information generation device 100 according to the present embodiment. The computer 900 includes a CPU 901, a ROM 902, a RAM 903, an SSD 904, an input/output interface 905 (denoted as I/O I/F in FIG. 5), a communication interface 906 (denoted as COMM I/F in FIG. 5), and a media interface 907 (denoted as MEDIA I/F in FIG. 5). The computer 900 may include a hard disc drive (HDD) instead of the SSD 904, or may further include an HDD in addition to the SSD 904.

The CPU 901 operates according to a program stored in the ROM 902 or the SSD 904 and performs control by the control part 110 (see FIG. 2). The ROM 902 stores a boot program executed by the CPU 901 when the computer 900 is activated, a program related to the hardware of the computer 900, and the like.

The CPU 901 controls an input device 910 such as a mouse and a keyboard and an output device 911 such as a display and a printer via the input/output interface 905. The CPU 901 acquires data from the input device 910 and outputs generated data to the output device 911 via the input/output interface 905.

The SSD 904 stores programs executed by the CPU 901, data used by the programs, and the like. The communication interface 906 receives data from other not-illustrated devices (for example, the nodes 230) via a communication network, outputs the data to the CPU 901, and transmits data generated by the CPU 901 to other devices via the communication network.

The media interface 907 reads a program or data stored in a recording medium 912 and outputs the read program or data to the CPU 901 via the RAM 903. The CPU 901 loads a program from the recording medium 912 on the RAM 903 via the media interface 907 and executes the loaded program. The recording medium 912 is an optical recording medium such as a digital versatile disk (DVD), a magneto-optical recording medium such as a magneto-optical disk (MO), a magnetic recording medium, a conductor memory tape medium, a semiconductor memory, or the like.

For example, when the computer 900 serves as the routing information generation device 100 according to the present embodiment, the CPU 901 of the computer 900 implements the function of the routing information generation device 100 by executing the program 128 (see FIG. 2) loaded on the RAM 903. The CPU 901 reads the program from the recording medium 912 and executes the program. The CPU 901 may read a program from another device via a communication network or may install the program 128 from the recording medium 912 to the SSD 904 and execute the program 128.

### Effects

The effects of the routing information generation device 100 will be described below.

A routing information generation device 100 according to the present embodiment includes: a period division part 112 configured to divide a generation period, which is a period for generating routing information for a network 200 including a node 230 that is a mobile node 210 or a fixed node 220, into one or more time slots to generate divided generation periods: a model generation part 113 configured to determine, for each time slot included in the one or more divided generation periods, whether communication is possible between two of the nodes 230 based on at least one of location information of the nodes 230 in a period indicated by the time slot, specifications of the nodes 230, and communication environment information at the locations of the nodes 230) and to generate a network model including a link between two of the nodes 230 between which communication is possible and the nodes 230; a routing part 114 configured to generate routing information for the network model: a model evaluation part 115 configured to calculate an evaluation value based on a communication quality of the network model: a selection part 116 configured to calculate an evaluation value of the divided generation period based on the evaluation values of the network models corresponding to the time slots included in the divided generation period and to select the divided generation period whose evaluation value is the best: and a node management part 111 configured to transmit, to the nodes 230), the time slots of the selected divided generation period and the routing information associated with the time slots.

According to such a routing information generation device 100, it is possible to perform calculation of routing in the network 200 including the mobile nodes 210 in advance taking into account the communication environment. This routing is calculated taking into account the communication environment in addition to the locations of the mobile nodes 210. Furthermore, as the routing information is calculated in advance, the usable time of the network 200 can be extended.

The period division part 112 according to the present embodiment divides the generation period so that a time slot continues as long as the communication quality of the network model satisfies a predetermined condition in the time slot.

According to such a routing information generation device 100, it is possible to reduce the number of the time slots and thus reduce the load for generating the routing information.

The period division part 112 according to the present embodiment divides the generation period so that a length of the time slot is short when a temporal change in a communication environment indicated by the communication environment information is large.

According to such a routing information generation device 100, it is possible to reduce the number of the time slots according to the communication environment and thus reduce the load for generating the routing information.

The routing part 114 according to the present embodiment calculates a cost of the link based on at least one of the location information of the nodes 230 in the period indicated by the time slot, the specifications of the nodes 230, and the communication environment information at the locations of the nodes 230, and generates the routing information.

According to such a routing information generation device 100, the routing information is generated based on the cost of the links for which not only the locations of the mobile nodes but also the communication environment information is taken into account. Therefore, it is possible to communicate through a communication path with better communication quality compared to a case where the routing information is generated without considering the communication environment.

The communication environment information according to the present embodiment includes weather information related to propagation loss in wireless communication of the nodes 230.

According to such a routing information generation device 100, it is possible to perform routing taking into account also the changes in the communication environment due to natural phenomena in the outer space caused by solar activity in addition to meteorology information on the earth.

### Reference Signs List

100 Routing information generation device
111 Node management part
112 Period division part
113 Model generation part
114 Routing part
115 Model evaluation part
116 Selection part
128 Program
130 Node information database
140 Environment information database
150 Model evaluation database
200 Network
210 to 215 Mobile node
220 to 222 Fixed node
230 Node
510, 520, 530 Divisional generation period (divided generation period)

1-7. (canceled)

8. A routing information generation device comprising:
a period division part configured to generate one or more divisional generation periods for a generation period for which routing information for a network is to be generated, the network comprising a plurality of nodes each of which is a mobile node or a fixed node, each of the one or more divisional generation periods being generated by dividing the generation period into one or more time slots;
a model generation part configured to, for each of the one or more time slots included in each of the one or more divisional generation periods,
determine, for each two of the plurality of nodes, whether communication is possible between the two of the plurality of nodes based on at least one of location information of the two of the plurality of nodes in a period of the time slot, specifications of the two of the plurality of nodes, and communication environment information at locations of the two of the plurality of nodes and
generate a network model including one or more links among communicable nodes and the communicable nodes, each of the communicable nodes being one of the plurality of nodes and determined as being communicable with another one of the plurality of nodes, each of the one or more links representing a link between corresponding two communicable nodes determined as communicable with each other;
a routing part configured to generate routing information for each network model;
a model evaluation part configured to calculate an evaluation value of each network model based on a communication quality of the network model;
a selection part configured to, for each of the one or more divisional generation periods, calculate an evaluation value based on the evaluation values of the network models corresponding to the one or more time slots included in the divisional generation period and to select a divisional generation period with a best evaluation value from the one or more divisional generation periods; and
a node management part configured to, based on each of the network models generated for the one or more time slots in the selected divisional generation period, transmit, to nodes corresponding to the routing information generated for the network model, information on the one or more time slots in the selected divisional generation period and the routing information generated for the network model.

9. The routing information generation device according to claim 8,
wherein the period division part divides the generation period into the one or more time slots such that at least one of the one or more time slots continues as long as the communication quality of the network model generated for the at least one of the one or more time slots satisfies a predetermined condition.

10. The routing information generation device according to claim 8,
wherein the period division part divides the generation period into the one or more time slots such that, for each of the one or more time slots, the larger a temporal change in a communication environment indicated by the communication environment information, the shorter the time slot.

11. The routing information generation device according to claim 8, wherein the routing part calculates a cost of each of the one or more links included in each network model based on at least one of the location information of the corresponding nodes in the period indicated by the corresponding time slot, the specifications of the corresponding nodes, and the communication environment information at the locations of the corresponding nodes, and generates the routing information of the network model based on the calculated costs.

12. The routing information generation device according to claim 8,
wherein the communication environment information includes weather information related to propagation loss in wireless communication of the two of the plurality of nodes.

13. A non-transitory medium storing a computer program for causing a computer to perform a routing information generation method comprising steps of:
generating one or more divisional generation periods for a generation period for which routing information for a network is to be generated, the network comprising a plurality of nodes each of which is a mobile node or a fixed node, each of the one or more divisional generation periods being generated by dividing the generation period into one or more time slots;
for each of the one or more time slots included in each of the one or more divisional generation periods,
determining, for each two of the plurality of nodes, whether communication is possible between the two of the plurality of nodes based on at least one of location information of the two of the plurality of nodes in a period of the time slot, specifications of the two of the plurality of nodes, and communication environment information at locations of the two of the plurality of nodes and
generating a network model including one or more links among communicable nodes and the communicable nodes, each of the communicable nodes being one of the plurality of nodes and determined as being communicable with another one of the plurality of nodes, each of the one or more links representing a link between corresponding two communicable nodes determined as communicable with each other;
generating routing information for each network model;
calculating an evaluation value of each network model based on a communication quality of the network model;
for each of the one or more divisional generation periods, calculating an evaluation value based on the evaluation values of the network models corresponding to the one or more time slots included in the divisional generation period and selecting a divisional generation period with a best evaluation value from the one or more divisional generation periods; and
based on each of the network models generated for the one or more time slots in the selected divisional generation period, transmitting, to nodes corresponding to the routing information generated for the network model, information on the one or more time slots in the selected divisional generation period and the routing information generated for the network model.

14. A routing information generation method to be executed by a routing information generation device, the method comprising:
generating one or more divisional generation periods for a generation period for which routing information for a network is to be generated, the network comprising a plurality of nodes each of which is a mobile node or a fixed node, each of the one or more divisional generation periods being generated by dividing the generation period into one or more time slots;
for each of the one or more time slots included in each of the one or more divisional generation periods,
determining, for each two of the plurality of nodes, whether communication is possible between the two of the plurality of nodes based on at least one of location information of the two of the plurality of nodes in a period of the time slot, specifications of the two of the plurality of nodes, and communication environment information at locations of the two of the plurality of nodes and
generating a network model including one or more links among communicable nodes and the communicable nodes, each of the communicable nodes being one of the plurality of nodes and determined as being communicable with another one of the plurality of nodes, each of the one or more links representing a link between corresponding two communicable nodes determined as communicable with each other;
generating routing information for each network model;
calculating an evaluation value of each network model based on a communication quality of the network model;
for each of the one or more divisional generation periods, calculating an evaluation value based on the evaluation values of the network models corresponding to the one or more time slots included in the divisional generation period and selecting a divisional generation period with a best evaluation value from the one or more divisional generation periods; and
based on each of the network models generated for the one or more time slots in the selected divisional generation period, transmitting, to nodes corresponding to the routing information generated for the network model, information on the one or more time slots in the selected divisional generation period and the routing information generated for the network model.
